(19) United States
(12) Patent Application Publication
(10) Pub. No.: US 2005/0030299 A1
(43) Pub. Date: Feb. 10, 2005

(54) Method of displaying images

(76) Inventor: Donald William Bursill, Guernsey (GB)

Correspondence Address: Matthew J. Booth & Associates, PLLC, P O BOX 50010, AUSTIN, TX, 78763-0010, US

(21) Appl. No.: 10/489,285

(22) PCT Filed: Sep. 11, 2002
(86) PCT No.: PCT/GB02/04137

(30) Foreign Application Priority Data
Sep. 11, 2001 (GB) 0121972.4

(51) Int. Cl. G09G 5/00

(52) U.S. Cl. 345/204; 345/475

(57) ABSTRACT

A method of presenting images corresponding to image data transmitted over a data link, the method comprising the steps of: receiving first image data corresponding to a first image; displying the first image; receiving second image data corresponding to a second image; displaying the second image; if third image data corresponding to a third image has been received before the expiry of an initial set period of time after the display of the second image, displaying the third image; or if the third image data has not been received before the expiry of the initial set period of time after the display of the second image, displaying the first image again.

THIS INVENTION relates to a method of displaying images, and in particular, to a method of displaying images corresponding to image data transmitted over a slow data link.

There are many circumstances in which people may wish to view an event in real time over the Internet, and in recent years a great number of Internet sites at which live images may be viewed have come into existence. However, files encoding images are often rather large, and may take a substantial length of time to be transferred over the Internet to the computer of a person who wishes to view a live event in this manner. Thus, if images of a live event are transmitted to a viewer over a slow data link, the image that the viewer sees on his or her screen may be refreshed at a slow rate, for instance only once every few seconds. Viewers often find such a slow refresh rate frustrating, and may quickly lose interest in the event being displayed.

It is an object of the present invention to seek to provide a method of displaying images corresponding to image data received over a slow data link that alleviates the above problem.

Accordingly, one aspect of the present invention provides a method of presenting images corresponding to image data transmitted over a data link, the method comprising the steps of: receiving first image data corresponding to a first image; displaying the first image; receiving second image data corresponding to a second image; displaying the second image; if third image data corresponding to a third image has been received before the expiry of an initial set period of time after the display of the second image, displaying the third image; or if the third image data has not been received before the expiry of the initial set period of time after the display of the second image, displaying the first image again.

Advantageously, the method further comprises the step, if the third image data were not received before the expiry of the initial set period of time after the display of the second image, of: if third image data corresponding to a third image has been received before the expiry of a further set period of time after the repeated display of the first image, displaying the third image; or if the third image data has not been received before the expiry of the further set period of time after the repeated display of the first image, displaying the second image again.

Preferably, the first and second images are displayed alternately, after successive periods of time, until the third image data has been received.

Conveniently, the set periods of time are substantially equal to one another.

Advantageously, the or each set period of time is determined by the rate at which data is transmitted over the data link.

Alternatively, the or each set period of time is predetermined by a user.

Alternatively, the or each set period of time is determined by the type of event represented by the images.

Another aspect of the present invention provides a method of presenting images corresponding to image data transmitted over a data link, the method comprising the steps of: establishing a data rate reception; determining whether the rate at which data is being received falls below the threshold; and presenting the images by a method according to any preceding claim if the rate falls below the threshold; or presenting the images as they are received over the data link, if the rate falls above the threshold.

A further aspect of the present invention provides a computer program adapted to: receive first image data over a data link, the first image data corresponding to a first image; display the first image; receive second image data over the data link, the second image data corresponding to a second image; display the second image; if third image data corresponding to a third image has been received before the expiry of an initial set period of time after the display of the second image, display the third image; or if the third image data has not been received before the expiry of the initial set period of time after the display of the second image, display the first image again, when said program is run on a computer.

Another aspect of the present invention provides a computer program according to the above, embodied on a computer readable medium.

A further aspect of the present invention provides a processing machine operable to: receive first image data over a data link, the first image data corresponding to a first image; display the first image; receive second image data over the data link, the second image data corresponding to a second image; display the second image; if third image data corresponding to a third image has been received before the expiry of an initial set period of time after the display of the second image, display the third image; or if the third image data has not been received before the expiry of the initial set period of time after the display of the second image, display the first image again.

Another aspect of the present invention provides a method of presenting images corresponding to image data transmitted over a data link, the method comprising the steps of: defining n registers; storing image data corresponding to the n most recently received images in the n registers; and displaying the n most recently received images in sequence until image data corresponding to the next image is received.

In order that the present invention may be more readily understood, embodiments thereof will now be described, by way of example, with reference to the accompanying drawings, in which:

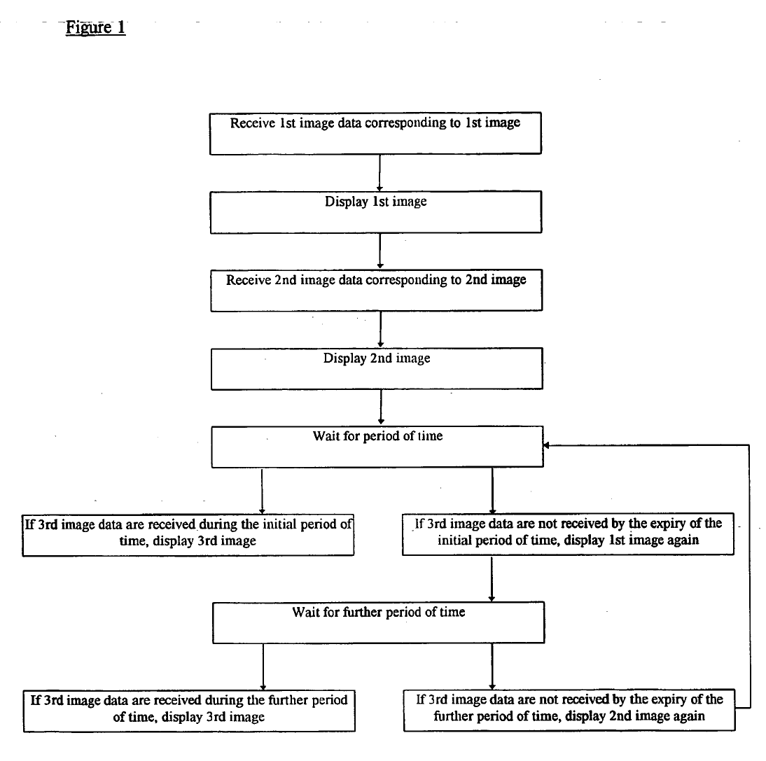

FIG. 1 is a flow chart representing the steps of a method embodying the present invention; and

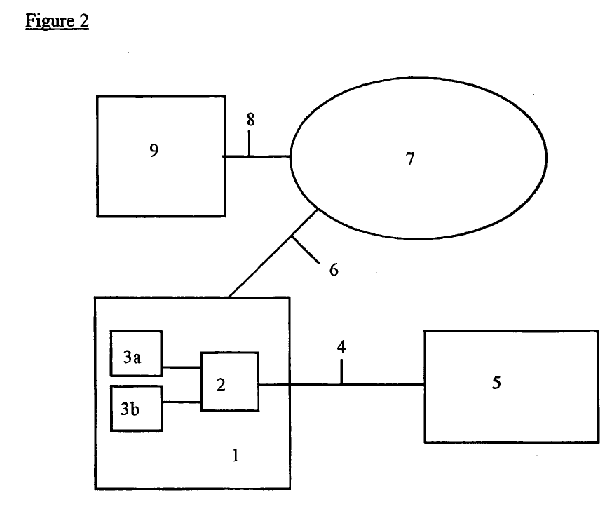

FIG. 2 is a schematic representation of a processing machine operable to carry out the method of FIG. 1.

Turning firstly to FIG. 1, the first step in the depicted method embodying the present invention is to receive first image data corresponding to a first image. In practice, this image data may be received by a processing machine, such as a laptop computer or a server, over a data link. The data link may comprise, for example, a connection to the Internet, to another network, or to another processing machine. Image data is received in a format which the processing machine is able to interpret as corresponding to discrete images, and encodes images which, when displayed in sequence, depict the progress of an event.

The next step in the method is to display the first image. This display may take any one of a variety of forms, such as display on a monitor, or projection onto a screen. A skilled person will immediately appreciate that there are many alternative methods by which the first image may be displayed.

Next, second image data corresponding to a second image is received, and the second image is displayed, replacing the first image.

The next step in the method is to begin to receive third image data, corresponding to a third image. If the third image data is received before the expiry of a set period of time, then the third image is displayed upon receipt thereof, replacing the second image. The length of the set period of time may vary in dependence upon a number of factors, as will be explained in greater detail below.

However, if the set period of time expires and the third image data has not been received, or has not been completely received, then the first image is displayed again, replacing the second image. Hence, after the set period of time has elapsed, even if image data corresponding to a new image has not been received over the data link, the second image is no longer displayed.

If the third image data was not fully received before the expiry of the set period of time, then the set period of time is allowed to elapse again. If, during this time, the third image data is received, then the third image is displayed upon receipt of the third image data, replacing the first image. However, if the third image data is not received during this time, then after the expiry of the set period of time, the second image is displayed again, replacing the first image. The set period of time is then allowed to elapse again while receipt of the third image data is awaited, and so on.

Once the third image data has been received and the third image displayed, the set period of time is allowed to elapse once more. If, during this time, fourth image data corresponding to a fourth image is received, the fourth image is displayed upon receipt of the fourth image data, replacing the third image. If, on the other hand, the fourth image data has not been received when the set period of time expires, then the second image is displayed again, replacing the third image. If the fourth image data has not been received after a further elapsing of the set period of time, then the third image is displayed again, replacing the second image, and so on.

In other words, after image data corresponding to a new image has been received, the processing machine displays the new image and stores two images, which are the image received immediately before the new image (the “previous” image), and the new image itself (the “current” image). Then, after the set period of time has elapsed, if image data corresponding to the next image has not been received, the processing machine displays the previous image, replacing the current image. Once the set period of time has elapsed again, if image data corresponding to the next image has still not been received, the processing machine displays the current image again, replacing the previous image.

The previous image and the current image are alternately displayed each time the set period of time has elapsed, until image data corresponding to the next image is received. At this point, the processing machine displays the next image, and stores this image as the current image. The image that had previously been stored as the current image is stored as the previous image, and the image that had previously been stored as the previous image is discarded. Then, the new current and previous images are displayed alternately until image data corresponding to the next image is received, and so on.

It has been found that this method of displaying images received over a slow data link provides a viewer of the images with a sense of constant change, and is far more pleasing to watch than being presented with individual images as and when they are received.

The length of the set period of time that is allowed to elapse before a previous image is presented may depend upon the rate at which image data is received, upon the type of event that the images represent, or may be set by a user in dependence upon his or her preference. Indeed, the set period of time may be altered as image data are received, and need not be constant throughout the receipt of a sequence of images. It has, however, been found that a delay of around one eighth of a second provides a pleasing refresh rate. In general, a data link that carries 56 kb/s will not transfer image data at a sufficiently high rate for images to create a pleasing refresh rate if they are displayed as and when they are received. However, image data transferred over a data link carrying 128 kb/s will be received at a sufficiently high rate for this mode of display to be feasible.

In a variant of the above method, images are displayed only when the set period of time elapses. In this embodiment, each time the set period of time elapses, the processing machine determines whether, during the set period of time, image data corresponding to a new image has been received. If so, the new image is displayed. If not, either the previous or the current image is displayed.

If the rate at which the image data are received is variable, then the processing machine may be operable to detect when the image data is being received at a sufficiently high rate to display the images as they are received. This threshold rate may, for example, be set by a user, may be determined by the hardware of the processing machine, or may simply default to a predetermined value. At this point, in this embodiment, the processing machine will stop employing the above method, and simply display the images in the sequence in which they are received, as they are received. If the rate at which the image data is received subsequently falls below the threshold rate at which the images can be so displayed, the processing machine will begin to use the above method again.

One situation in which the present invention may find particular application is in the field of Internet betting. Visitors to a certain website may be able to view the spinning of a roulette wheel in real time, and place bets on the outcome of the spin. If the visitor's connection to the Internet is slow, then the visitor may be presented with a stationary image of a roulette wheel for several seconds, and the visitor may find this lack of movement frustrating, and ultimately lose interest in the game.

However, when a method embodying the present invention is employed, the last two images of the wheel to be received over the visitor's data link may be alternately presented to the visitor in quick succession, and it has been found that such an arrangement provides a pleasing and convincing illusion that the visitor is watching the roulette wheel spin in real time.

Turning to FIG. 2, a schematic representation of a processing machine 1 operable to carry out the above method is shown. The processing machine 1 also comprises a link 4 to a monitor 5, on which images may be displayed.

In addition to the above, the processing machine 1 is provided with a data link 6 to the Internet 7, which in turn has a second data link 8 to a remote processing machine 9, from which the image data originates. As described above, image data is received by the processing machine 1 over the data link 6, and first and second image data representing the first and second images is stored in the first and second registers 3a, 3b respectively by the processor 2. Until image data corresponding to the third image is received over the data link 6, the processor 2 causes the first and second images to be displayed alternately on the display 5.

When the third image data corresponding to the third image is received, the third image data is stored in the second register 3b. The processor 2 then transfers the second image data to the first register 3a, and deletes the first image data. The images stored in the registers 3a, 3b (which are now the second and third images) are alternately displayed until the fourth image data is received, and so on.

In the above embodiment, the processing machine has two registers, in which the current and the previous images are stored while image data corresponding to the next image is being received. However, it is envisaged that the present invention may be implemented with a greater number of registers, in which the most recently received images are stored, and displayed in succession while image data corresponding to the next image are being received. In addition, the processing machine may cycle through the images stored in any number of the n registers, and not necessarily cycle through all of these images. The number of the registers so used may be set by a user, or may depend upon other factors, such as the type of event represented by the images.

A person of ordinary skill in the art will readily appreciate how such an n-register method could be implemented, and it is envisaged that values of n between, for example, 2 and 10 may be appropriate in different circumstances.

It will be understood that the present invention provides a powerful method for presenting images corresponding to image data received over a slow data link, that is likely to hold the attention of a viewer for far longer than would be the case if the images were simply displayed as they were received.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1-15. (Canceled.) claim 16. A method that presents images corresponding to image data transmitted over a data link, comprising:
receiving first image data corresponding to a first image over a data link;
displaying said first image;
receiving second image data corresponding to a second image over said data link;
displaying said second image; and
displaying a third image, if third image data corresponding to said third image has been received over said data link before the expiry of a first set period of time after the display of said second image; or
displaying said first image a second time, if said third image data has not been received over said data link before the expiry of said first set period of time after the display of said second image.

17. The method of claim 16, wherein said third image data corresponding to said third image is not received over said data link before the expiry of said first set period of time after the display of said second image, further comprising:
displaying said third image if said third image data corresponding to said third image has been received over said data link before the expiry of a second set period of time after said second display of said first image; or
displaying said second image a second time if said third image data has not been received over said data link before the expiry of said second set period of time after said second display of said first image.

18. The method of claim 17, further comprising alternately displaying said first image and said second image until said third image data has been received over said data link.

19. The method of claim 17, wherein said first set period of time and said second set period of time are substantially equal to one another.

20. The method of claim 16, wherein said first set period of time is determined by the rate at which data is transmitted over said data link.

21. The method of claim 16, wherein said first set period of time is determined by a user.

22. The method of claim 16, wherein said first set period of time is determined by the type of event represented by said first, second, and third images.

23. The method of claim 16, 17, or 18, further comprising:
establishing a data rate reception threshold;
determining whether the rate at which data is being received falls below said data rate reception threshold; and
presenting images as data corresponding to said images is received over the said data link if said rate is above said data rate reception threshold.

24. A program storage device readable by a machine, tangibly embodying a program of instructions executable by the machine to perform a method that presents images corresponding to image data transmitted over a data link, said method comprises:
receiving first image data corresponding to a first image over a data link;
displaying said first image;
receiving second image data corresponding to a second image over said data link;
displaying said second image; and
displaying a third image, if third image data corresponding to said third image has been received over said data link before the expiry of a first set period of time after the display of said second image; or
displaying said first image a second time, if said third image data has not been received over said data link before the expiry of said first set period of time after the display of said second image.

25. The program storage device of claim 24, wherein said method further comprises:
displaying said third image if said third image data corresponding to said third image has been received over said data link before the expiry of a second set period of time after said second display of said first image; or
displaying said second image a second time if said third image data has not been received over said data link before the expiry of said second set period of time after said second display of said first image.

26. The program storage device of claim 25, wherein said method further comprises alternately displaying said first image and said second image until said third image data has been received over said data link.

27. A display apparatus that presents images corresponding to image data transmitted over a data link, comprising:
a data link that receives first image data corresponding to a first image, second image data corresponding to a second image, and third image data corresponding to a third image;
a display that displays said first, second, and third images;
wherein, said third image is displayed only if said third image data is received before the expiry of a first set period of time after the display of said second image;
otherwise, said first image is displayed a second time.

28. The display apparatus of claim 27, wherein said first image is displayed a second time, and wherein said third image is displayed only if said third image data is received before the expiry of a second set period of time after said first image is displayed a second time;
otherwise, said second image is displayed a second time.

29. The display apparatus of claim 28, wherein further said first image and said second image are alternately displayed until said third image data has been received over said data link.

30. A display system that presents images corresponding to image data transmitted over a data link, comprising:
a data link that receives first image data corresponding to a first image, second image data corresponding to a second image, and third image data corresponding to a third image;
a display that displays said first, second, and third images;
wherein, said third image is displayed only if said third image data is received before the expiry of a first set period of time after the display of said second image;
otherwise, said first image is displayed a second time.

31. The display system of claim 30, wherein said first image is displayed a second time, and wherein said third image is displayed only if said third image data is received before the expiry of a second set period of time after said first image is displayed a second time;
otherwise, said second image is displayed a second time.

32. The display apparatus of claim 31, wherein further said first image and said second image are alternately displayed until said third image data has been received over said data link.

33. A method that makes a display apparatus that presents images corresponding to image data transmitted over a data link, comprising:
providing a data link that receives first image data corresponding to a first image, second image data corresponding to a second image, and third image data corresponding to a third image;
providing a display that displays said first, second, and third images;
wherein, said third image is displayed only if said third image data is received before the expiry of a first set period of time after the display of said second image;
otherwise, said first image is displayed a second time.

34. The method of claim 33, wherein said first image is displayed a second time, and wherein said third image is displayed only if said third image data is received before the expiry of a second set period of time after said first image is displayed a second time;
otherwise, said second image is displayed a second time.

35. The method of claim 34, wherein further said first image and said second image are alternately displayed until said third image data has been received over said data link.

36. A method that presents images corresponding to image data transmitted over a data link, comprising:
defining a sequence of n registers;
storing image data corresponding to the n most recently received images in sequence in said sequence of n registers in a one-to-one correspondence; and
repeatedly displaying the sequence of said n most recently received images until image data corresponding to the next image is received.

37. A program storage device readable by a machine, tangibly embodying a program of instructions executable by the machine to perform a method that presents images corresponding to image data transmitted over a data link, said method comprising:
defining a sequence of n registers;
storing image data corresponding to the n most recently received images in sequence in said sequence of n registers in a one-to-one correspondence; and
repeatedly displaying the sequence of said n most recently received images until image data corresponding to the next image is received.

38. A display apparatus that presents images corresponding to image data transmitted over a data link, comprising:
a sequence of n registers;
image data received over a data link, said image data corresponds to the n most recently received images in sequence, said image data is stored in said sequence of n registers in a one-to-one correspondence; and
a display that repeatedly displays the sequence of said n most recently received images until image data corresponding to the next image is received.

39. A method that makes a display apparatus that presents images corresponding to image data transmitted over a data link, comprising:
providing a sequence of n registers;
providing image data received over a data link, said image data corresponds to the n most recently received images in sequence, said image data is stored in said sequence of n registers in a one-to-one correspondence; and
providing a display that repeatedly displays the sequence of said n most recently received images until image data corresponding to the next image is received.

40. A display system that presents images corresponding to image data transmitted over a data link, comprising:
a sequence of n registers;
image data received over a data link, said image data corresponds to the n most recently received images in sequence, said image data is stored in said sequence of n registers in a one-to-one correspondence; and
a display that repeatedly displays the sequence of said n most recently received images until image data corresponding to the next image is received.
